(19) United States
(12) Patent Application Publication
(10) Pub. No.: US 2025/0250067 A1
(43) Pub. Date: Aug. 7, 2025

(54) SEALING INSERTS FOR CROWN CORKS WITH REDUCED METAL-SHEET THICKNESS

(71) Applicant: ACTEGA DS GMBH, Bremen (DE)

(72) Inventor: Matthias Kern, Lilienthal (DE)

(21) Appl. No.: 18/856,952

(22) PCT Filed: May 2, 2023
(86) PCT No.: PCT/EP2023/061541

§ 371 Date: Oct. 15, 2024

(30) Foreign Application Priority Data
May 12, 2022 (WO) PCT/EP2022/062996

(51) Int. Cl. B65D 41/12; C08L 23/06; C08L 53/02; C08L 91/00

(52) U.S. Cl. CPC B65D 41/125; C08L 23/06; C08L 53/02; C08L 91/00; C08L 2205/025; C08L 2205/035; C08L 2207/322

(57) ABSTRACT

Crown cork for a vessel for holding beverages or foods that has a mouth to be closed with the crown cork, having a sealing insert arranged in the crown cork such that it sealingly closes the mouth when the crown cork is mounted on the vessel, where the crown cork including the sealing insert contains no halogen-containing materials, where the sheet metal used for the crown cork has a thickness of 0.10-0.19 mm, wherein the sealing insert contains at least twenty percent by weight, based on the total weight of the sealing insert, of at least one, preferably fully hydrogenated, styrene triblock copolymer, especially styrene-ethylene-butadiene-styrene copolymer (SEBS), SEEPS and/or SEPS, or a mixture of two or more of these copolymers.

The invention in general relates to container closures produced from metal and/or plastic, in particular crown corks, with a sealing insert based on a polymer for bottles and other containers in order to hold beverages and foodstuffs. In particular, the invention relates to such container closures, in particular crown corks, which are provided with a sealing insert. The container closures are free from halogenated materials and are also suitable for demanding applications, in particular in the case of crown corks with reduced sheet thickness.

Different types of containers are filled with beverages and foodstuffs for the purposes of transport and storage or safekeeping. Frequently, these containers have to be capable of being sealed so that the contents do not leak out and in addition, are protected from the ingress of unwanted materials which could contaminate or damage the contents. In many applications, these are not simply solid or liquid contaminants. If the contents are sensitive to gaseous substances, these also have to be prevented from gaining access. This is achieved by an appropriately configured container closure.

Container closures produced from metal and/or plastic have been known for a long time. In the form of screw caps, screw closures and crown corks, for example, they serve to tightly seal containers such as bottles, glasses and the like. Such containers have a mouth which has to be sealed by the container closure. In this regard, a sufficiently tight seal of the container has to be ensured in order on the one hand to prevent the container contents from leaking out, and on the other hand to protect the container contents from the ingress of unwanted materials, including gaseous substances such as oxygen, trichloroanisole and others.

The necessary imperviousness is usually achieved by means of a sealing insert which consists on the one hand of a sufficiently hard, but on the other hand also elastic material and is disposed in the container closure in a manner such that it comes into contact with the mouth of the container when the container closure is disposed on the container. The sealing insert is usually disposed on the inside of the container closure in the form of a disk or ring. In the closed state of the container, it is seated on the container mouth and is pressed against the mouth by the container closure, whereupon its hardness together with its elasticity makes the seal. In this regard, a good sealing insert compensates for the unevennesses of the container mouth which are always present. Thus, the more uneven is the container mouth, the higher are the demands placed on the sealing insert.

An essential factor when meeting such demands is the suitable choice of materials for the sealing insert. Many known materials are extremely suitable for relatively simple applications, but less so or entirely not so for more demanding seals.

In this regard, the sealing insert must also satisfy other requirements, for example they should be capable of being pasteurized or even sterilized for many purposes. They should (for example in the case of carbonated beverages) be able to withstand a considerable internal pressure which, however, if exceeded, should yield in a controlled manner (pressure relieving valve action).

If the container closure is a screw closure (for example a twist crown), the sealing insert must not have too much resistance to twisting the container closure on the mouth when opening.

In addition, the sealing insert should be able to be manufactured as cheaply and easily as possible and be affixed to the container closure. Cutting disk-shaped sealing inserts out of webs or films and then attaching them to the container closure (“out-shell moulding”) or, which is often preferred, introducing them into the container closure in a flowable form, then overmoulding there and consolidation (“in-shell moulding”), is known. In-shell moulding also means that sealing inserts can be produced which are not disk-shaped but are ring-shaped.

In the case of polymer-based sealing inserts, this is normally carried out by introduction as a plastisol with subsequent moulding and drying, or in the case of thermoplastic materials by introduction in the heated, flowable state, subsequent moulding and cooling.

While PVC-containing sealing inserts have previously been widely used, PVC and other halogenated materials now give rise to considerable concerns. They are considered to be potentially harmful to health and are also difficult to dispose of easily. In many countries, the use of such halogenated materials is regulated by law or regulations, or even prohibited.

Thus, there is a considerable need for container closures which do not have halogenated materials which can be used without dispensing with the advantages in this regard of, for example, PVC-containing sealing inserts as regards processing, sealing properties, costs and the like.

A plurality of proposals in this regard have already been provided in the prior art.

Thus, for decades, sealing inserts (both for screw closures and also for closures which have to be pried off, such as conventional crown corks) have been produced on the basis of polymers which contain no halogens. In these sealing inserts, they are invariably “compounds”, i.e. mixtures of one or (usually) more polymers with additives which adjust the properties of the sealing insert to the intended purpose, facilitate their process or use, and the like.

Typical polymers in such compounds are thermoplastics, above all polyolefins, thermoplastic elastomers, elastic thermoplastics and synthetic rubbers. Typical additives are plasticizers, oils, glide agents, antioxidants, stabilizers, pigments, fillers and the like.

The permeability to impurities in polymer-based sealing inserts depends on the choice of their components. Such impurities may, for example, pass between the sealing insert and the container mouth if the sealing insert is not seated on the mouth in an optimal manner. They may also be soluble in the material of the sealing insert and diffuse into the container. The sealing insert must therefore be optimized as regards its mechanical properties (in particular hardness and elasticity) and its chemical properties (solubility of impurities).

Adding one or more substances to the material of a sealing insert which chemically bind the incoming oxygen and therefore “capture” it—and are therefore also known as “scavengers”—is already known. An example in this regard is sodium sulphite, which is incorporated into the sealing insert in the form of solid particles with a suitable particle size.

However, there is still a need for sealing inserts without halogenated materials which enable an improved sealing action to be obtained, even with problematic and demanding applications, in particular in the applications which will be described in more detail below:

A special problem which can be solved by means of the invention arises with container closures which can be pried off or twisted off, in particular crown corks.

Here, the usual containers, typically beer bottles and bottles for carbonated soft drinks and mineral water, are mass-produced products with a fluctuating quality in the mouth region as regards unevennesses, hairline cracks and the like. Beverages such as beer, soft drinks and mineral water are susceptible to alterations in the flavour which, as appropriate, are caused by oxidation following the ingress of oxygen, and/or by the ingress of flavour-altering substances such as trichloroanisole.

Thus, the storage periods are usually short.

In the prior art, there are sealing inserts which ensure a sufficient seal with conventional crown corks.

However, manufacturers are increasingly demanding the use of thinner tinplate for such crown corks.

While conventional crown corks in Europe have a sheet thickness of 0.20 to 0.23 mm, working with sheet thicknesses of 0.19 mm and below, down to 0.15 mm, would be desirable in order to economise on material.

A crown cork produced from thinner tinplate with an identical yield strength, however, cannot reliably press the sealing insert which is incorporated into it against the container mouth with the same force as a conventional crown cork produced from thicker sheet metal. A reduction in the thickness of the tinplate leads to an overall decrease in the sealing performance (internal pressure resistance).

This effect can be counteracted on the one hand by using optimized seals in respect of hardness and elasticity, or mechanically improved tinplate with a higher yield strength.

Seals with an optimized ratio of hardness to elasticity are only one important component in being able to use thinner tinplate for crown corks. In addition, a tinplate with a higher yield strength should be employed.

While tinplate alloys with a maximum yield strength of 415 MPa are used for standard crown corks, for crown corks with a thickness of 0.18 mm, tinplate with a yield strength of 415 to 620 MPa should be used, and for crown corks with a thickness of 0.15 mm, tinplate with a yield strength of >620 MPa should be used.

The maximum possible yield strength or rigidity of tinplate is determined by the forming process when deep drawing the crown cork.

In order to obtain an optimal ratio of ductility to strength, the thinner (<0.20 mm) tinplate is preferably produced using what is known as the “double reduced” process; if not, the risk of damage during forming of the crown cork (premature tearing) is significantly increased.

In order to manufacture steel for packaging, in particular tinplate, in this process, what are known as hot strips with a thickness of approximately 1.5-4.0 mm are used.

Firstly, the hot strip is pickled and then cold rolled.

The first thickness reduction of the tinplate occurs during the cold rolling.

So that the high deformations can be produced as a result of the thickness reduction, the roller nip is lubricated with a mixture of water and roller oil.

In addition, the tinplate has to be cooled with water, because heat is generated by the rolling process.

Next, the work hardening has to be removed by an annealing process, because the substantial thickness reduction makes the tinplate very hard and brittle and therefore it would be unsuitable as a packaging material.

However, before annealing can be carried out, the cold rolled tinplate has to be degreased.

Annealing the tinplate ensures that its malleability is restored.

Next, by means of dry rerolling without any lubrication and cooling, a further reduction in the thickness of the tinplate is obtained.

The “double reduced” material produced in this manner enables tinplate to be fabricated which compensates for smaller thicknesses by higher strengths.

Next, tinning or chromium plating of the tinplate is carried out for the purposes of corrosion protection until it is finally conditioned into different packaging sizes.

Tinplate for steel for packaging and crown corks fabricated therefrom are specified in accordance with DIN EN 10202 or EN17177.

Thus, the need arises for improved container closures.

The aim of the invention is to provide improved closures which not only can be used generally, but also can be used for the particularly demanding applications discussed herein.

In the light of the foregoing, it is an important objective of the invention to propose improved crown corks without halogenated materials with a sealing insert which not only can be configured as screw closures, but also as closures which can be pried off and can be manufactured more easily, and therefore more inexpensively.

A further important objective of the invention is to provide such crown corks with an improved imperviousness, in particular as regards leakages, even in the case of mass-produced containers such as beer bottles and the like.

In this regard, the good barrier effect of the known sealing insert should be retained.

The objectives of the invention include the provision of such container closures with a sealing insert which can be produced by means of in-shell moulding.

The sealing insert should be able to be very soft in configuration, in order to be able to reliably seal the bottles even in the case of hairline cracks and similar defects on the mouth.

Further objectives and advantages of the invention will become apparent from the following description, including the exemplary embodiments.

These and other objectives of the invention are met by the combination of features of the independent patent claims.

Advantageous configurations are defined in the dependent claims.

In the detailed description of the invention which now follows, firstly, definitions and features are dealt with which are of general significance to the invention and its optional embodiments independently of the individual exemplary embodiments. The definitions provided above should be taken into consideration and do not contradict the discussions below. Unless specified otherwise in the description, technical terms have their usual meanings.

The invention will now be illustrated with the aid of individual exemplary embodiments.

### Definitions and Measurement Methods

In the context of this application, a “container closure” is a crown cork which is preferably configured as a conventional crown cork which can be pried off, or as a twist crown with the usual dimensions. It consists of a body produced from metal and/or plastic and a sealing insert disposed therein. The container closure may be a screw closure (with threaded elements including cams and the like) or a generally “pry-off” closure which can be removed (without twisting the container closure), including crown corks, snap-on lids and the like. A stopper is not a container closure in this context.

A “sealing insert” in the context of the invention is a principally disk-shaped or ring-shaped (optionally provided with a profile) shaped part which either consists entirely of a homogeneous polymer compound, or comprises at least two different, respectively homogeneous materials, at least one of which is a homogeneous polymer compound.

The term “in-shell moulding” should not only be understood to mean the known process in which a polymer compound which has been made flowable using heat is inserted into the closure body and stamped to form a disk-shaped sealing insert (SACMI or Zapata process), but also those processes in which the polymer compound is inserted by injection, optionally only in the edge region of the sealing surface, and moulded into a ring-shaped sealing insert.

In the context of the invention, “polymer compounds” are mixtures of one or (usually) more polymers with additives (for example plasticizers, anti-blocking agents, glide agents, antioxidants, stabilizing agents, fillers, pigments, etc), which adapt the properties of the compound to the intended purpose, facilitate its processing or use, and the like.

A thermoplastic elastomer is an industrially produced polymer with elastic properties which are founded on the molecular structure. Typical thermoplastic elastomers are (block) copolymers of styrene and butadiene, also with the addition of other monomers (ethylene, isoprene, etc.).

Percentages in this description are percentages by weight with respect to the total weight, insofar as they are proportions of components in a product produced from a plurality of components.

The melt flow rate (MFR) provides the flowability of a material or mixture of materials at 190° C. and under 5 kg of load. It is determined in accordance with DIN EN ISO 1133-1 and is given in g/10 min and is determined using conventional commercial melt index test instruments, for example from ZwickRoell.

The Shore D hardness provides the hardness of a material or mixture of materials. It is determined in conformity with ASTM D 2240 on at least 6 mm-thick press plates. The measurement time is 5 s. The relevant specimens were produced at 180° C. by melting under pressure and subsequent cooling to 23° C. (holding time 30 min).

The Shore A hardness is determined in an analogous manner to the Shore D hardness, in conformity with ASTM D 2240. Here again, the measurement time is 5 s.

The compression set is a measure of the recovery (permanent deformation) of a material or mixture of materials. The specimens are produced in an analogous manner to that for the Shore hardness measurement at temperatures between 170 230° C. The specimens have a diameter of 13 mm and a thickness of 6.3 mm. The dimensional tolerances are in accordance with DIN ISO 815-1. The specimens concerned are conditioned in accordance with the same standard and siliconized. During the compression set test, the relevant specimen is subjected to a compression of 25% for 22 h at a respective given temperature. After a loading time of 22 h, the pressure on the specimen is relieved and after 30 min, the thickness of the specimen is measured or the permanent deformation is determined. It is also measured in accordance with DIN ISO 815-1 at the respectively given temperature after loading for 22 hours and given as a percentage permanent compression, with respect to the specimen prior to compression.

A compression set of 25% therefore corresponds to a permanent “compression” of the specimen by a quarter of the original height (thickness).

In the context of the invention, a compound is processable when it can be processed in a conventional manner on standard equipment for the manufacture of container closures with polymer-based sealing inserts.

A material in accordance with the invention is pasteurizable when, in an industrial pasteurization at 60° C. to 85° C., it enables a gas-tight closure to be produced and it does not lose its properties for use in the envisaged application.

The following parameters were selected for sealing tests with crown corks (also in accordance with the invention):

The bottle mouths consisted of glass, in accordance with DIN EN ISO 12821 CC 26 H180.

The sealing ring had an appropriate internal diameter of 28.25 mm and 28.3 mm (if steel mouths were taken into consideration).

The sealing force was 300 kg. The sealing speed was 15 mm/s. Pasteurization was carried out at 68° C. for 20 min (holding time) in a spray pasteurizer.

The figures provide an overview of the tests which were carried out and their results:

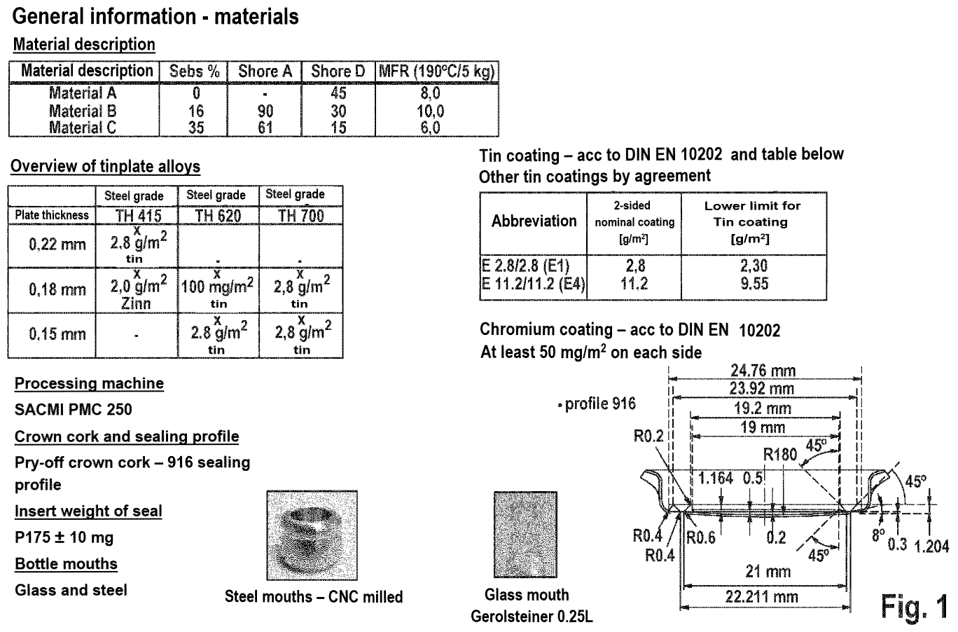

FIG. 1 is a summary of parameters of the sealing compounds and crown cork blanks employed.

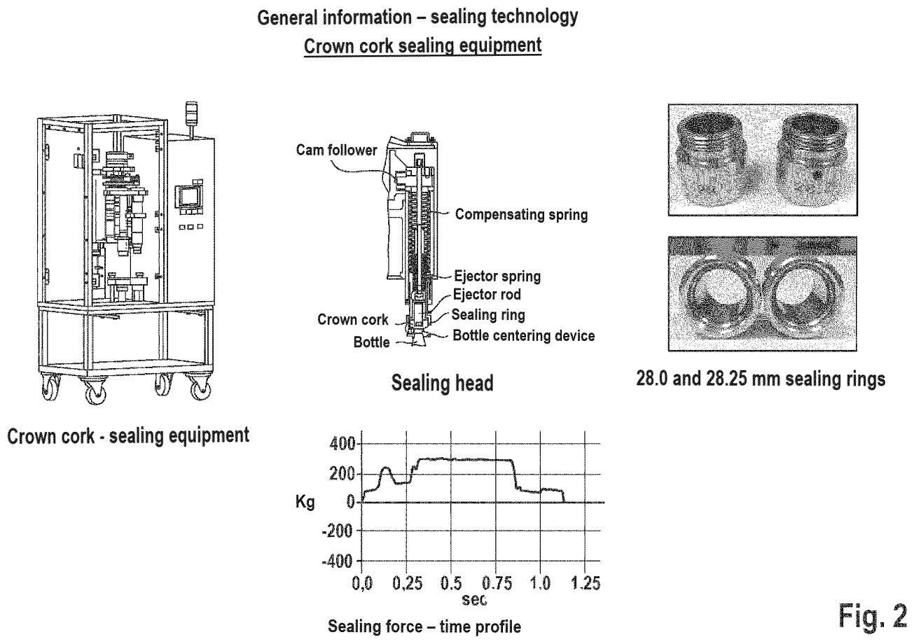

FIG. 2 diagrammatically shows the sealing technology used.

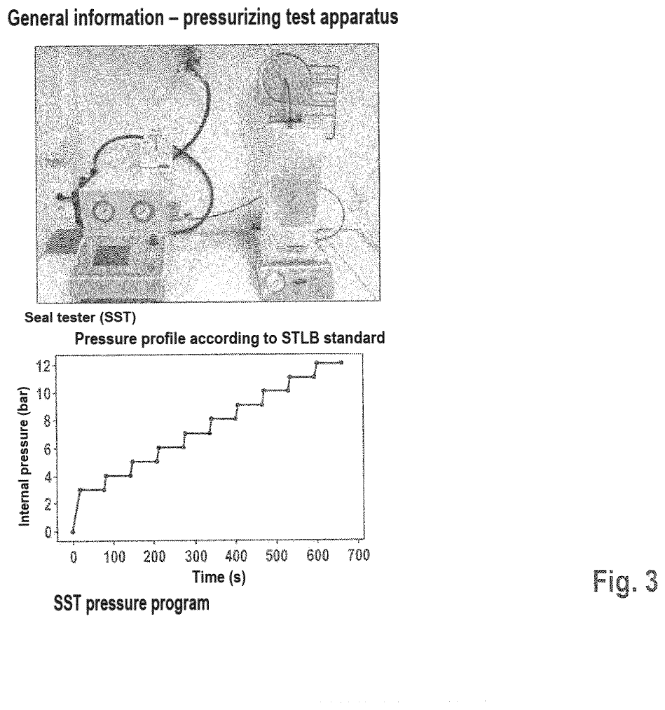

FIG. 3 shows the pressurizing test device used.

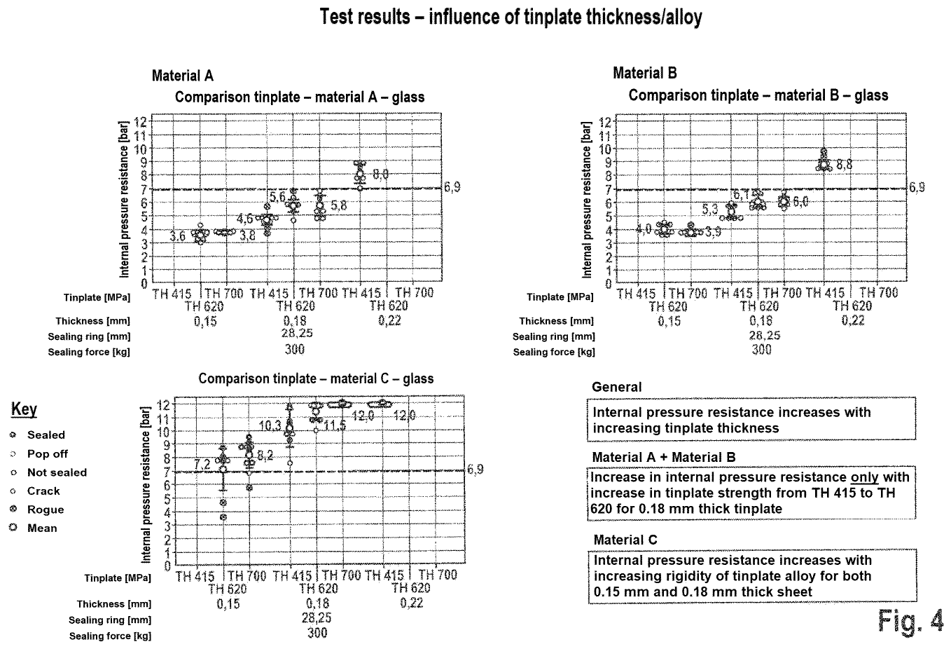

FIG. 4 shows the results of sealing tests with different sealing compounds.

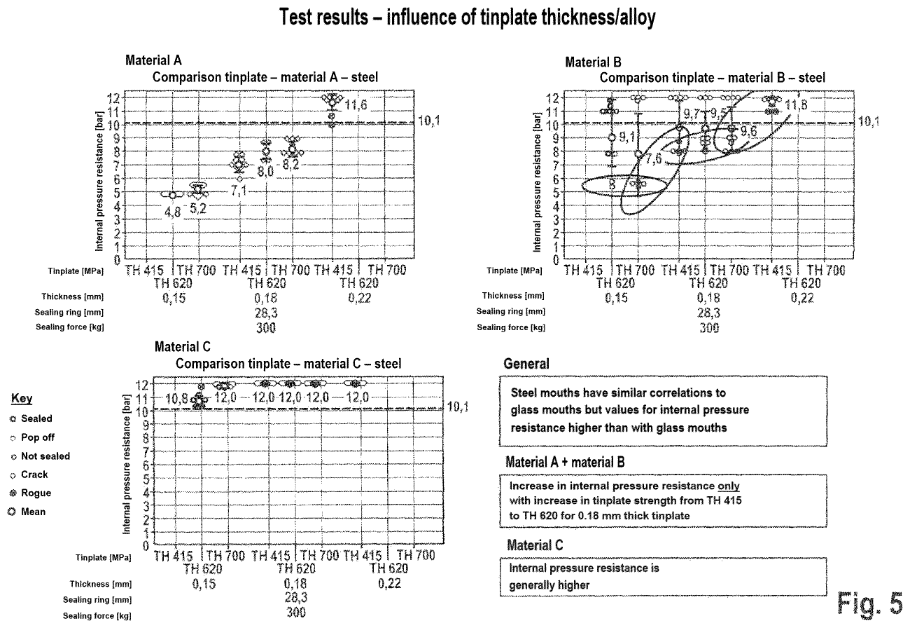

FIG. 5 shows analogous results to FIG. 4.

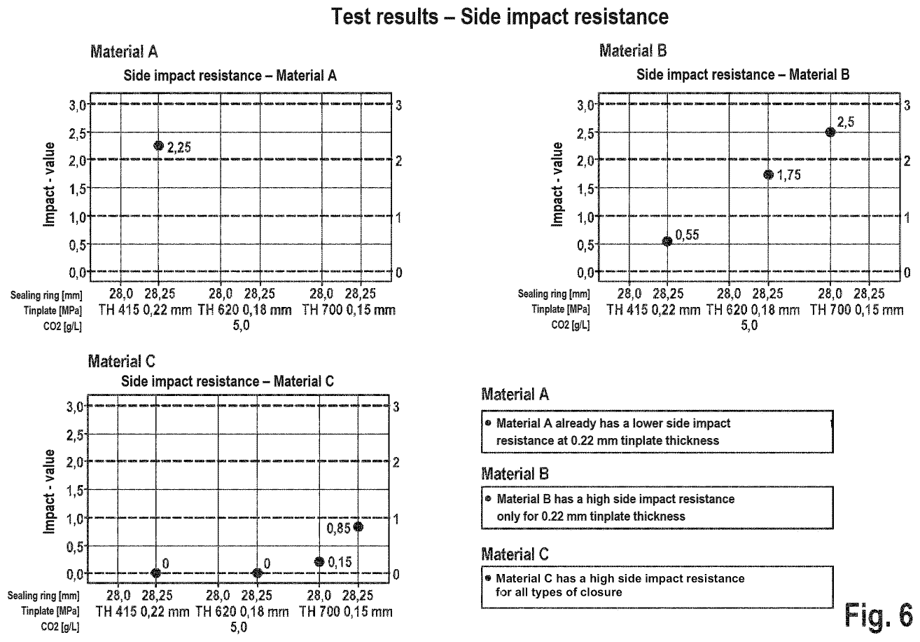

FIG. 6 shows results of side impact resistance tests.

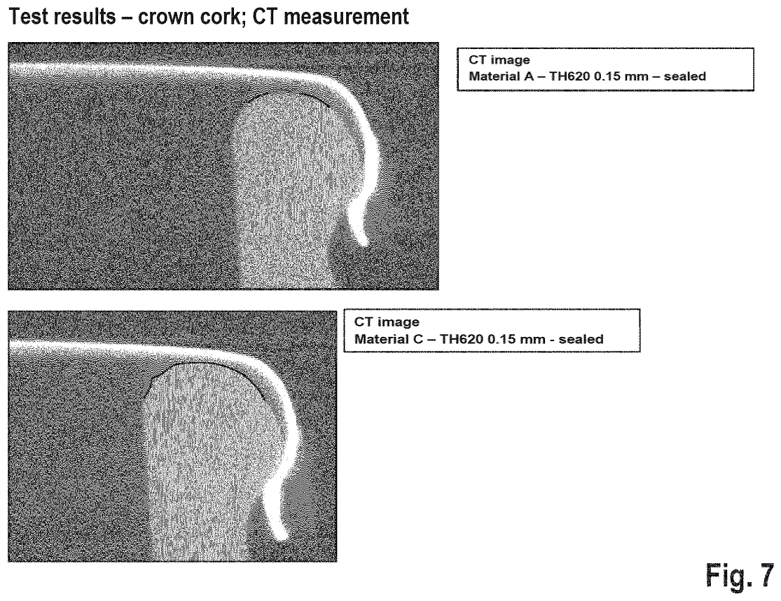

FIG. 7 shows results in respect of the seal of different crown corks; only material C is in accordance with the invention.

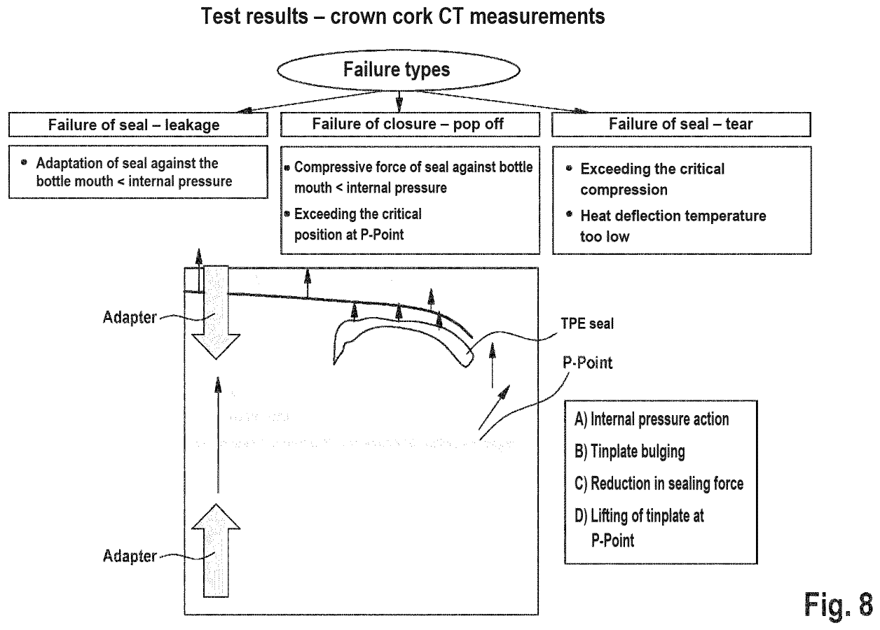

FIG. 8 shows analogous results to FIG. 7, in detail.

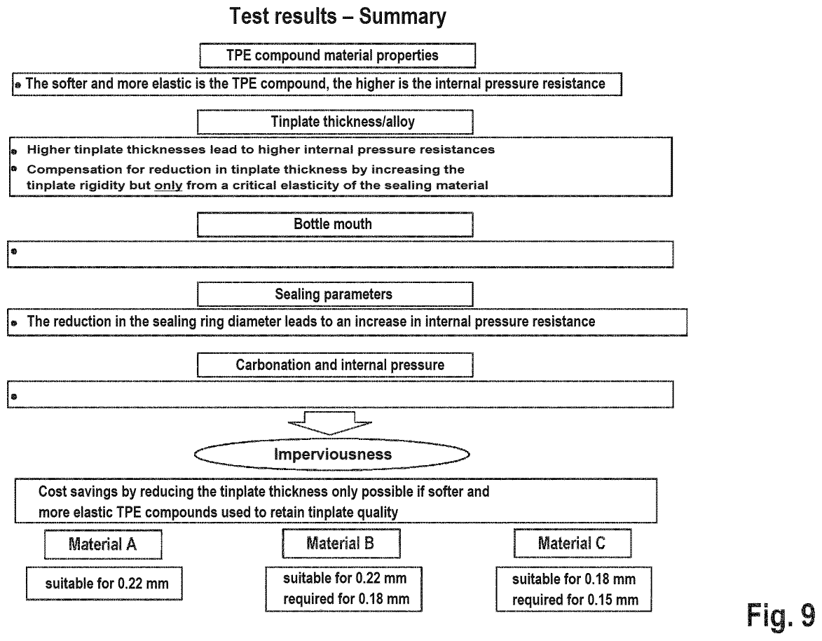

FIG. 9 is an overview of test results.

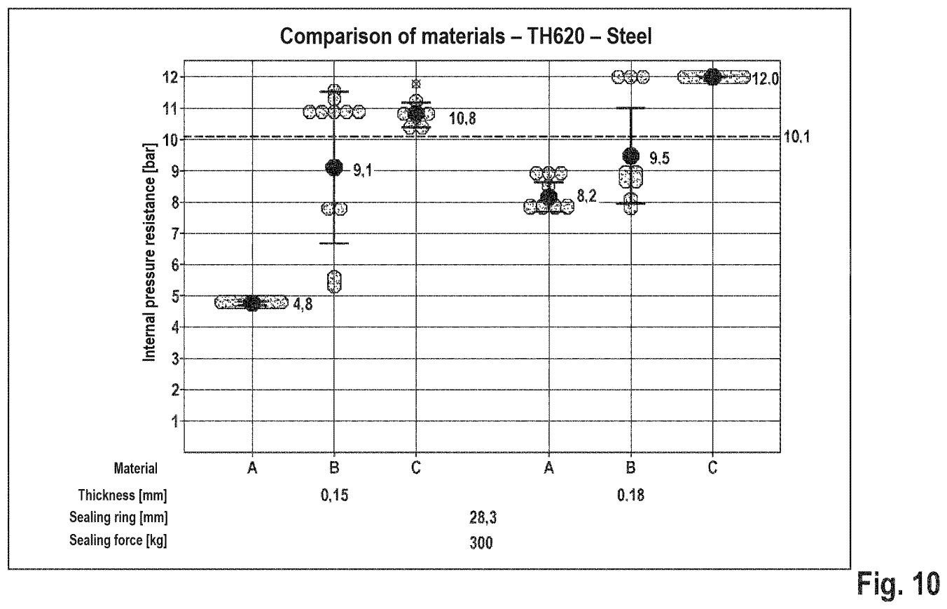

FIG. 10 shows results regarding the internal pressure resistance for different materials.

It can be seen that crown corks in accordance with the invention have better technical properties in comparison with crown corks which have a lower SEBS content.

The formulations employed are shown in Table I:

TABLE I

| | A | B | C |
|---|---|---|---|
| SEBS | — | 16.0 | 35.0 |
| Med. white oil | — | 16.0 | 35.0 |
| PE-LD | 84.8 | 52.8 | 14.8 |
| PP-CoPo | 15 | 15.0 | 15.0 |
| Stabilizers | 0.2 | 0.2 | 0.2 |
| Oil/SEBS | 0 | 1.00 | 1.00 |
| Shore A hardness | 95 | 90 | 61 |
| Shore D hardness | 45 | 30 | 15 |
| Compression set (23° C., 25% | — | 25.6 | 15.9 |
| Compression) | | | |
| Compression set (70° C., 25% | — | 58.4 | 40.2 |
| compression) | | | |

1. A crown cork, for a container for holding beverages or foodstuffs, which has a mouth for sealing with the crown cork, with a sealing insert which is disposed in the crown cork in a manner such that it tightly seals the mouth when the crown cork is applied to the container,
wherein the crown cork including the sealing insert contains no halogenated materials, wherein the sheet metal used for the crown cork has a thickness of 0.10-0.19 mm,
wherein the sealing insert contains at least twenty percent by weight, with respect to the total weight of the sealing insert, of at least one styrene triblock copolymer, the styrene triblock copolymer being one of styrene-ethylene-butadiene-styrene copolymer (SEBS), SEEPS and/or SEPS, or a mixture of a plurality thereof.

2. The crown cork as claimed in claim 1, in which the sheet metal employed has a maximum thickness of 0.20 mm.

3. The crown cork as claimed in claim 1, in which the sheet metal is tinplate with a maximum thickness of 0.19 mm and with a yield strength of at least 415 MPa.

4. The crown cork as claimed in claim 3, in which the sheet metal has a maximum thickness of 0.18 mm with a yield strength between 415 and 620 MPa.

5. The crown cork as claimed in claim 1, wherein the sealing insert contains between 20 and 50% by weight SEBS.

6. The crown cork as claimed in claim 1, wherein the sealing insert contains between 33 and 38% by weight SEBS.

7. The crown cork as claimed in claim 1, wherein the sealing insert contains at least 20% by weight of oil, wherein the oil content (as a % by weight) is as high as the styrene triblock copolymer content.

8. The crown cork as claimed in claim 1, wherein the sealing insert further comprises PE-LD or PP-CoPo.

9. The crown cork as claimed in claim 1, in which the sealing insert has a Shore A hardness at room temperature (23° C.) of 40-75.

10. The crown cork as claimed in claim 1, in which the sealing insert has a compression set, determined in accordance with DIN ISO 815-1, of 10 to 25% at 70° C.

11. The crown cork as claimed in claim 1, in which the SEBS component of the sealing insert has a solution viscosity in toluene (15% by weight, 25° C.) of ≥50 mPa·s.

12. The crown cork as claimed in claim 1, in which the sealing insert has a SEBS component with a styrene content of between 27 and 35% by weight.

13. The crown cork as claimed in claim 1, in which the oil-to-SEBS ratio of the sealing insert is between 0.7:1 and 1.3:1.

14. The crown cork as claimed in claim 1, in which the sealing insert has at least 14% plasticizer—white oils with a kinematic viscosity at 40° C. between 60 and 350 cSt and/or liquid (C2-C20) polyalphaolefins with the same viscosity.

15. The crown cork as claimed in claim 1, in which the sealing insert has 15 to 60% by weight polyolefins, the polyolefins comprising PE and PP and C₄-C₈ copolymers thereof, as well as mixtures thereof.

16. The crown cork as claimed in claim 1, in which the sealing insert has up to 20% by weight of polybutene (and C2/C3 CoPos) or polystyrene.

17. The crown cork as claimed in claim 1, in which the sealing insert has up to 20% by weight of fillers.

18. The crown cork as claimed in claim 1, which is configured as a twist crown.

19. The crown cork as claimed in claim 1, the sheet metal of which at least partially comprises tinplate and/or steel or aluminum.
